(19) United States
(12) Patent Application Publication
(10) Pub. No.: US 2006/0177092 A1
(43) Pub. Date: Aug. 10, 2006

(54) Speaker and method for manufacturing the speaker

(76) Inventor: Yoshizumi Ohta, Fujiyoshida-shi (JP)

Correspondence Address: BRINKS HOFER GILSON & LIONE, P.O. BOX 10395, CHICAGO, IL, 60610, US

(21) Appl. No.: 11/349,748

(22) Filed: Feb. 8, 2006

(30) Foreign Application Priority Data
Feb. 9, 2005 (JP) JP2005-033682

(51) Int. Cl. H04R 9/06; H04R 1/00; H04R 11/02

(52) U.S. Cl. 381/423; 381/412

(57) ABSTRACT

A method of manufacturing a speaker includes providing an integral set of frames each with a receptacle opening, mounting a plurality of magnetic circuit units in the respective receptacle openings of the integral set of frames, mounting an integral set of diaphragms to the integral set of frames with diaphragms aligned with respective frames, mounting a plurality of voice coils to the integral set of diaphragms with the voice coils operatively connected to the respective magnetic circuit units to form an integral set of speaker units each comprising the frame, the magnetic circuit unit, the diaphragm and the voice coil, and dividing the integral set of speakers into individual speakers each with at least one speaker unit.

This application claims priority under 35 U.S.C. § 119 to Japanese Patent Application No. 2005-033682 filed Feb. 9, 2005, the entire content of which is hereby incorporated by reference.

### FIELD OF THE INVENTION

The present invention generally relates to a micro speaker (hereinafter, simply referred to as a “speaker”) for use in a cellular phone and other devices and a method for manufacturing this kind of speaker.

### BACKGROUND OF THE INVENTION

An electroacoustic transducer or speaker is incorporated into, for example, a cellular phone as shown in Japanese patent application publication No. 2003-143676. Traditionally, speakers of this kind speaker is manufactured on a one-by-one basis. Attempts have been made to manufacture a speaker on a mass production basis, but such attempts were inefficient and unable to reduce the cost of manufacture and provide high yields.

It is, therefore, an object of the present invention to make it possible to more efficiently manufacture a speaker than the conventional art.

### SUMMARY OF THE INVENTION

According to the present invention, there is provided a method for manufacturing speakers which includes the steps of (a) providing an integral set of frames, wherein a plurality of frames are juxtaposed end to end and integrally connected together, (b) providing a plurality of magnetic circuit units, (c) providing an integral set of diaphragms wherein a plurality of diaphragms are juxtaposed end to end and integrally connected together, (d) providing a plurality of voice coils each formed into a cylindrical shape, (e) mounting the plurality of magnetic circuit units into the integral set of frames, respectively, so that each of the plurality of magnetic circuit units is received in a receptacle opening of a corresponding frame, (f) mounting the integral set of diaphragms to the integral set of frames in such a manner that each of the plurality of diaphragms is aligned with a corresponding frame, (g) mounting the plurality of voice coils to the plurality of diaphragms, respectively, so that each of the plurality of voice coils is operatively connected a corresponding magnetic circuit unit, to thereby form an integral set of speaker units each comprising one each from the frames, the magnetic circuit units, the diaphragms and the voice coils; and (h) dividing the integral set of speaker units into a plurality of speakers, each speaker comprising at least one speaker unit.

This method brings about a reduction in the number of jigs required to position various speaker parts relative to each other and the number of positioning steps as compared with the prior art wherein speakers are individually manufactured. It is therefore possible for the method to more efficiently manufacture speakers with a high level of accuracy than the prior art. The integral set of speaker units can be so cut as to provide a speaker with the required number of speaker units. The present invention is therefore suitable for making, for example, a stereo sound speaker and a surround sound speaker. Further, in the present invention, a plurality of frames and a plurality of diaphragms are also provided in an integral fashion. This leads to reduction of the number of molding steps and thus, of the production cost of the speaker, as compared to the conventional art wherein a frame and a diaphragm are made one by one.

In one embodiment, in the step (b), each of the magnetic circuit units comprises an outer yoke having a bottom wall and a cylindrical wall elevating from a peripheral edge of the bottom wall, a magnetic element mounted on the bottom wall, an inner yoke mounted on the magnetic element, wherein an annular magnetic gap is defined between the outer yoke and the inner yoke, and a flange extending radially outwardly from the cylindrical wall. In the step (e), the flanges are engaged with the respective frames.

In another embodiment, in the step (c), each of the diaphragms includes a central moving part, a radially outer moving part disposed around the central moving part, and an annular groove part connected between and having a U-shape in cross section. In the step (f), the annular groove parts are located along the respective magnetic gaps, and the outer moving parts each have a peripheral edge secured to the respective frames. In the step (g), the voice coils are secured within the respective annular groove parts.

This embodiment facilitates mounting of the voice coils to the integral set of diaphragms.

In a further embodiment, there is provided a locator jig. The integral set of frames is positioned relative to the locator jig. In the step (f), the integral set of diaphragms is positioned relative to the locator jig to thereby position the integral set of diaphragms relative to the integral set of frames.

The single locator jig is used to assemble a multiplicity of speaker units. This embodiment enables speaker units to be manufactured with high yields as well as a high level of accuracy, as compared to the prior art wherein speaker units are manufactured one by one.

In one embodiment, the locator jig includes a generally flat jig body and a plurality of locator pins projecting from the jig body. The integral set of frames includes a plurality of locator holes, and the integral set of diaphragms includes a plurality of locator holes. The locator pins are inserted through the respective locator holes of the integral set of frames and the respective locator holes of the integral set of diaphragms so as to position the integral set of frames and the integral set of diaphragms relative to the locator jig.

In another embodiment, a double-sided adhesive sheet is used and corresponds in shape to the integral set of frames. The double-sided adhesive sheet placed on the integral set of frames while being is positioned relative to the locator jig. The integral set of diaphragms is secured to the integral set of frames through the double-sided adhesive sheet.

In a further embodiment, in the step (b), each of the outer yokes has a fixed pin extending axially and centrally from the bottom wall of the outer yoke and branches at its top end. Each of the magnetic elements is annular in shape and has a hole through which the pin extends, and each of the inner yokes is annular in shape and has a hole through which the pin extends. The branches of the pin are bent so that the magnetic element and the inner yoke are pressed and held between the bottom wall of the outer yoke and the bent branches.

Conventionally, an outer yoke, a magnetic element, and an inner yoke are interconnected by means of an adhesive. According to the present invention, the outer yoke, the magnetic element and the inner yoke can be joined together without the need for an adhesive. Thus, the present invention enables a magnetic circuit unit to be effectively manufactured with a lesser number of production steps.

In one embodiment, the magnetic element is magnetized before the integral set of speakers is divided in the step (h).

In accordance with the other aspect of the present invention, there is provided a speaker comprising at least one speaker unit. The speaker unit comprises an outer yoke having a bottom wall and a cylindrical wall elevating from a peripheral edge of the bottom wall, a magnetic element placed on the bottom wall, an inner yoke placed on the magnetic element, wherein an annular magnetic gap is defined between the outer yoke and the inner yoke, a frame accommodating and supporting the magnetic circuit unit, a diaphragm secured to the frame, and, a cylindrical voice coil secured to the diaphragm and extending into the annular magnetic gap. The frame may comprise a printed circuit to which the voice coil is to be connected and which comprises terminals for connection with an external electronic component. The printed circuit makes it easy to electrically mount the voice coil onto the frame to thereby contribute to reduction in the production cost of the speaker. The magnetic element has a central hole extending therethrough in an axial direction of the cylindrical wall of the outer yoke and the inner yoke has a hole aligned with the hole of the magnetic element in the direction of the axis. The outer yoke has a fixed pin secured to extending in the direction of the axis of the cylindrical wall from the bottom wall of the outer yoke through the holes of the magnetic element and the inner yoke. The fixed pin has branches at its top end. The branches hold together the magnetic element and the inner yoke between the branches and the bottom wall of the outer yoke. The diaphragm may have an annular groove part plunging into the magnetic gap and having U-shape in cross section. The voice coil is secured in the groove part.

### BRIEF DESCRIPTION OF THE DRAWINGS

The present invention may be best understood by reference to the following description when taken in conjunction with the accompanying drawings in which:

FIG. 1 is a top plan view of a speaker made according to one embodiment of the present invention;

FIG. 2 is a side view of the speaker shown in FIG. 1;

FIG. 3A is a sectional view of the speaker;

FIG. 3B is an enlarged view, in part, of the speaker as encircled as at B;

FIG. 3C is an enlarged view, in part, of the speaker as encircled as at C;

FIG. 4 is a bottom plan view of the speaker;

FIG. 5 is a flow chart showing the manner in which the speaker is manufactured according to the present invention;

FIG. 6a is a top plan view of an integral set of frames;

FIG. 6b is a bottom plan view of the integral set of frames shown in FIG. 6a;

FIG. 7a is a plan view of a locator jig for use in the method of the present invention;

FIG. 7b is a sectional view taken on the line VIIb-VIIb in FIG. 7a;

FIG. 8 is an exploded sectional view showing the manner in which a magnetic circuit unit is assembled;

FIG. 9 is a partial plan view showing the manner in which the magnetic circuit unit is mounted;

FIG. 10 is a partial plan view showing the manner in which an adhesive sheet is attached:

FIG. 11 is a partial plan view showing the manner in which an integral set of diaphragms is mounted;

FIG. 12 is a partial plan view showing the manner in which a voice coil is mounted;

FIG. 13 is a partial plan view showing the manner in which an adhesive sheet is attached;

FIG. 14a is a partial plan view showing the manner in which an integral set of protective members is mounted:

FIG. 14b is a bottom plan view, in part, of the integral set of protective members shown in FIG. 14a;

FIG. 15 is a partial plan view showing the manner in which an adhesive sheet is attached;

FIG. 16 is a partial plan view showing the manner in which a rear mesh is attached; and

FIG. 17 is a partial plan view showing the manner in which an integral set of speakers is divided.

### DETAILED DESCRIPTION OF THE PREFERRED EMBODIMENTS

The present invention will now be described with reference to the accompanying drawings.

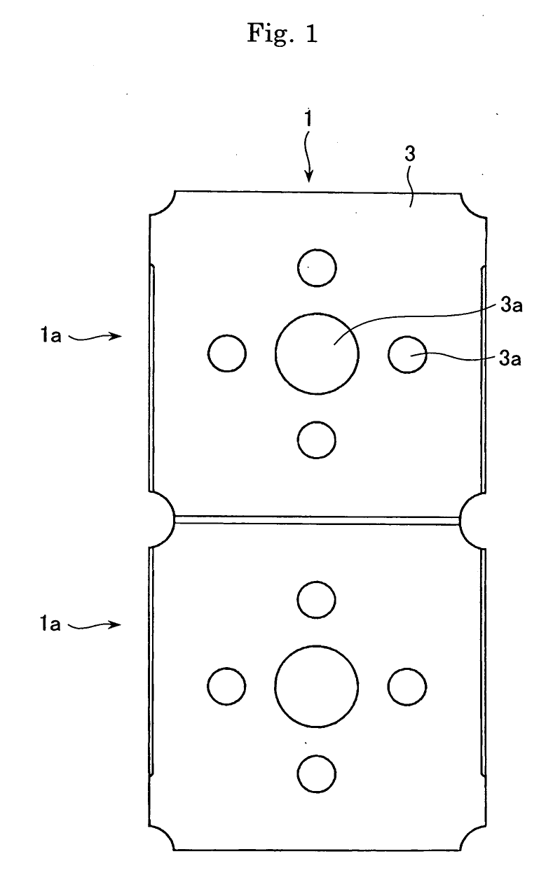

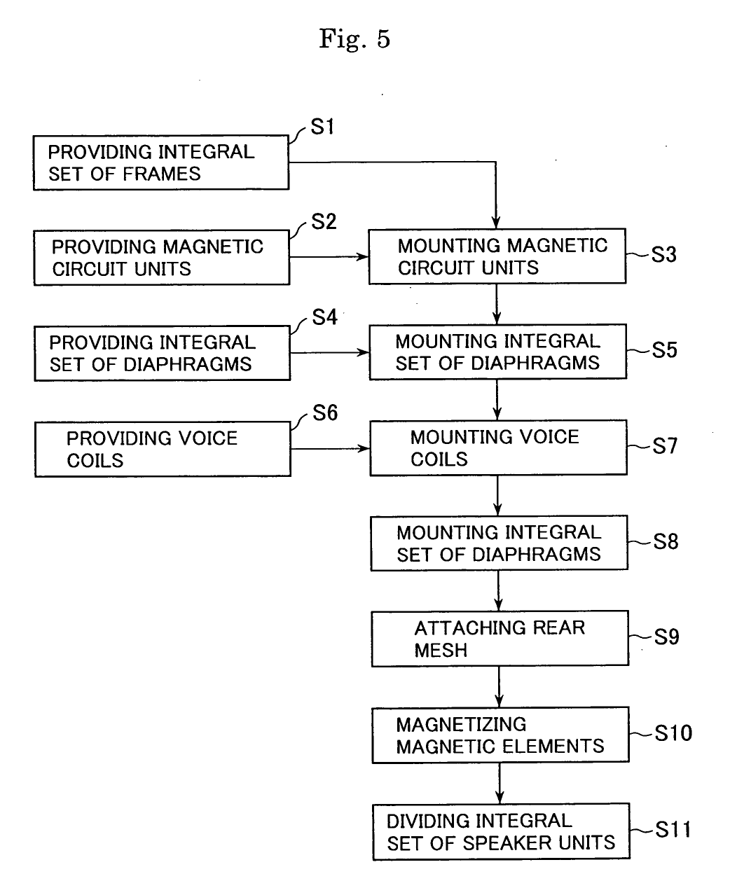

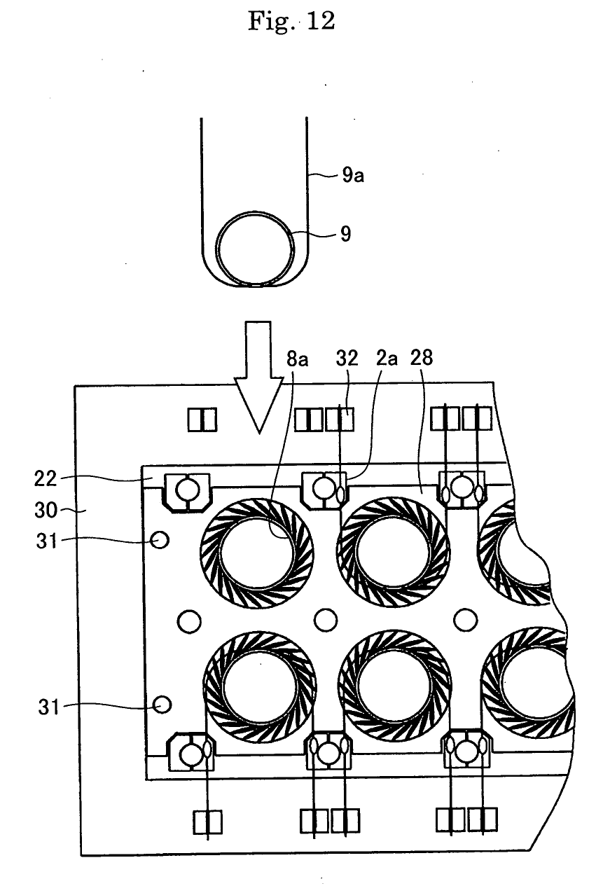

Referring now to FIGS. 1 to 4, there is illustrated a speaker 1 made according to the present invention. A specific method for manufacturing the speaker 1 is illustrated in FIGS. 5 to 17 and will later be described in detail. The speaker 1 includes two independent acoustic transducers or speaker units 1a, 1a.

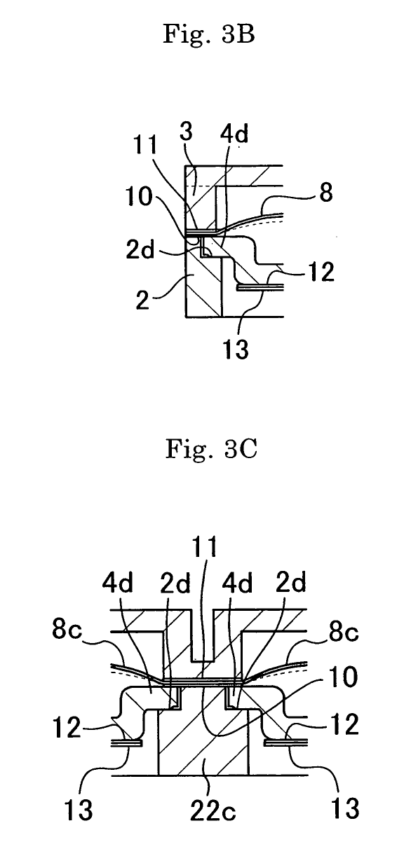

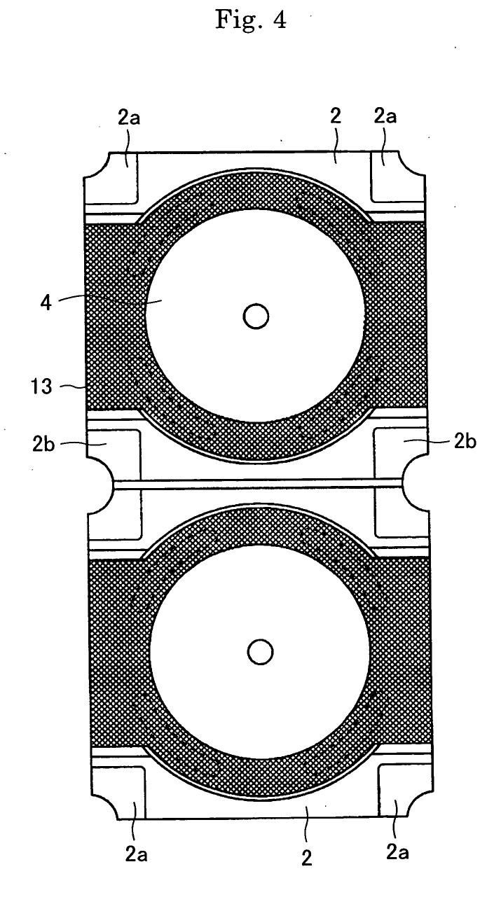

As shown better in FIGS. 3 and 4, each of the speaker units 1a, 1a has a generally square frame 2 having a circular receptacle opening 22c, a magnetic circuit unit 7 arranged in the receptacle opening 22c and composed of a pan-shaped outer yoke 4, a magnetic element 5, a top plate or inner yoke 6, a voice coil 9 inserted into a magnetic gap g formed in the magnetic circuit unit 7, a moving diaphragm 8 attached to the voice coil 9, a protective member 3 mounted on the frame 2 to protect the diaphragm 8 and having sound holes 3a, 3a, and a rear mesh 13 as a dust cover. The frame 2 comprises a printed circuit.

Illustratively, the frames 2, 2 of the two speaker units 1a, 1a are arranged in a juxtaposed relationship and formed in an integral fashion. This is also true of the diaphragms 8, 8 and the protective members 3, 3.

The outer yoke 4 includes a bottom wall 4a and a cylindrical wall 4b extending upwardly from the peripheral edge of the bottom wall 4a. A flange 4c extends radially outwardly from the top end of the cylindrical wall 4b. The flange 4c has a stepped peripheral edge portion 4d supported on an annular recessed portion 2d formed along the inner upper peripheral edge of the frame 2.

The permanent magnet 5 and the top plate 6 are both annular in shape. The permanent magnet 5 and the top plate 6 are arranged on the bottom wall 4a of the outer yoke 4 in a coaxial relation to the cylindrical wall 4b. A fixed axial pin 4e extends centrally from the bottom wall 4a of the outer yoke 4 and is formed at its top end with two bent branches 4f, 4f. The two bent branches 4f, 4f cooperate with the bottom wall 4a of the outer yoke 4 to hold together the permanent magnet 5 and the top plate 6 therebetween.

The diaphragm 8 is made of synthetic resin. The two diaphragms 8, 8 are juxtaposed end to end and integrated together. The peripheral edge of each of the diaphragms 8, 8 is sandwiched between the frame 2 and the stepped peripheral portion 4d and the protective member 3. The diaphragm 8 includes an annular groove part 8a having a U-shape cross section, a circular central moving part 8b located radially inwardly of the annular groove part 8a and an annular moving part 8c located radially outwardly of the annular groove part 8a. The voice coil 9 is inserted into the annular groove part 8a and fixed thereto. The voice coil 9 has a terminal soldered to a terminal 2a on the frame 2.

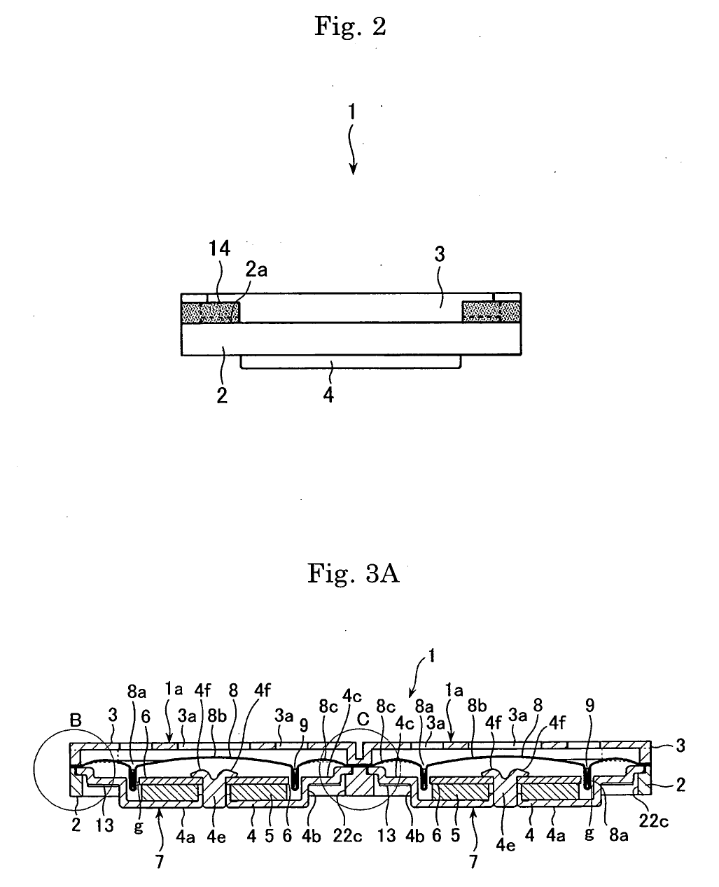

As shown in FIG. 2, the terminal 2a is covered with an encapsulating resin 14. A double-sided adhesive tape 10 is employed to adhesively connect the diaphragm 8 to the frame 2 and the stepped peripheral edge portion 4d. Similarly, a double-sided adhesive tape 11 is employed to join the diaphragm 8 and the protective member 3 together. A double-sided adhesive tape 12 is employed to join the outer yoke 4 and the rear mesh 13 together.

Referring next to FIGS. 5 to 17, there is illustrated a method for manufacturing the speaker.

As shown in FIG. 5, the method includes a step S1 of providing an integral set of frames, a step S2 of providing a plurality of magnetic circuit units, a step S3 of mounting the magnetic circuit units to the integral set of frames, a step S4 of providing an integral set of diaphragms, and steps S5 to S11 of assembling the integral set of frames, the magnetic circuit units, the integral set of diaphragms and a plurality of voice coils together.

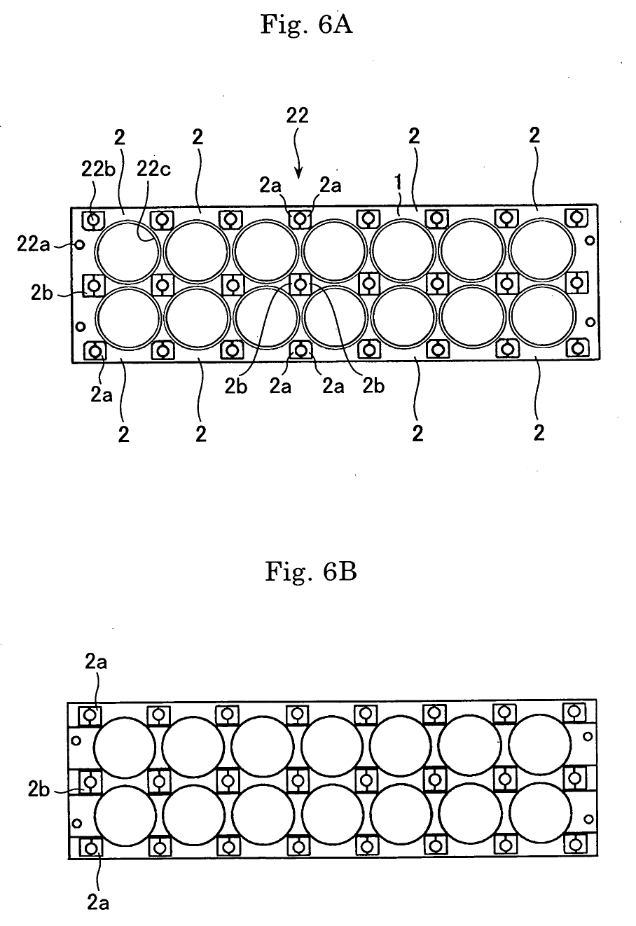

In the step S1, there is provided an integral set of frames 22 wherein a first or upper array of frames 2 (seven frames 2 are shown) and a second or lower array of frames 2 (seven frames 2 are shown) are integrally formed together and extend parallel to each other, as shown in FIGS. 6a, 6b. FIG. 6a shows the front face of the integral set of frames 22, whereas FIG. 6b shows the rear face of the integral set of frames 22. As mentioned earlier, each speaker 1 shown in FIG. 3 is composed of a pair of frames 2, 2 which correspond to the frames 2,2 in the upper and lower arrays, respectively. In order to receive the magnetic circuit unit, the receptacle opening 22c is defined in each of the frames 2, 2. The terminals 2a are formed at either side of the respective openings 22c on the front and rear faces of the integral set of frames 22. The integral set of frames 22 further has like terminals 2b which will not be used in the speaker as will be noted from the following description. The terminals 2b are formed through a production process of the integral set of frames 22 in which there is first provided an integral set of frames having a larger number of frames than the embodiment shown in FIGS. 6a and 6b (where two arrays of seven frames are provided). The integral set of the larger number of frames is then cut to produce a plurality of the integral set of frames 22 such that each receptacle opening 22c of the integral set of frame 22 can have associated terminals 2a, regardless of how the integral set of the larger number of frames is cut. The integral set of frames 22 further has through vias 22b and through locator holes 22a, the through via 22b connecting the terminal 2a on the front face of the integral set of frames 22 and the corresponding terminal 2a on the rear face of the same. The integral set of frames 22 is fabricated through a conventional method for producing a printed circuit board so that the integral set of frames comprises the through locator holes 22a, the terminals 2a, the through vias 20 and the receptacle openings 22c.

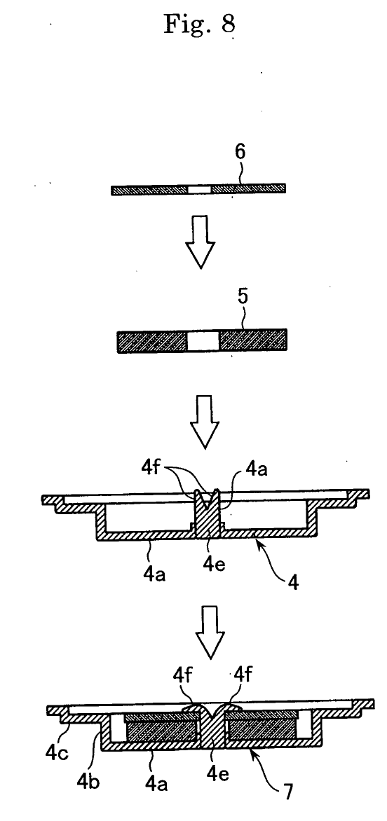

In the step S2, the magnetic element 5 is placed on the bottom wall 4a of the outer yoke 4, and the inner yoke 6 is placed on the magnetic element 5 as shown in FIG. 8. At this time, the pin 4e extends through the central opening of each of the magnetic element 5 and the inner yoke 6. The branches 4f of the pin 4e are then bent outwardly to clamp the magnetic element 5 and the inner yoke 6 between the branches 4f and the bottom wall 4a of the outer yoke 4 to complete assembly of the magnetic circuit unit.

In the step S3, each magnetic circuit unit 7 is mounted to the integral set of frames 22.

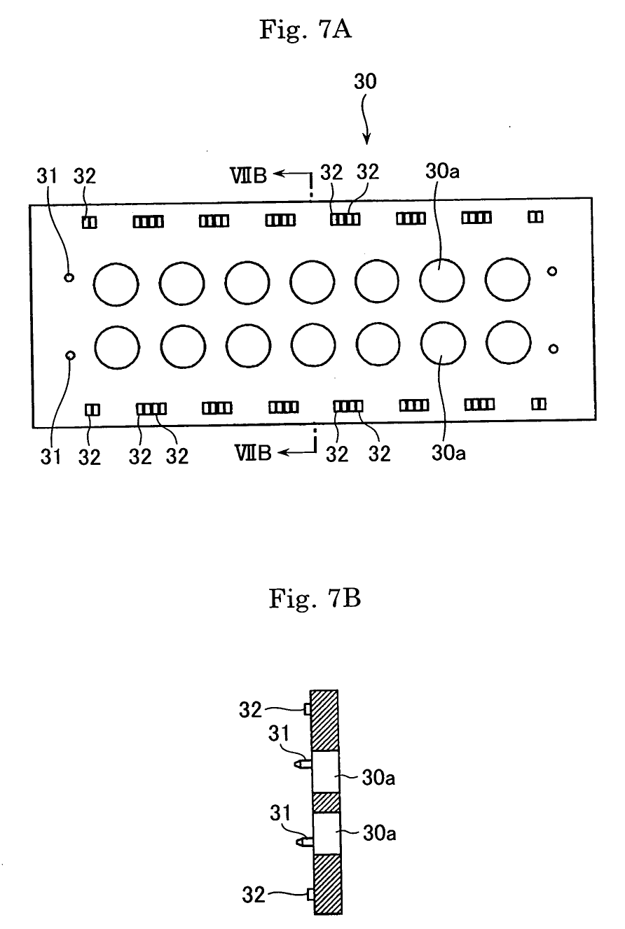

In the step S3, an elongated jig 30 is employed, as shown in FIGS. 7a and 7b. The jig 30 is in the form of a generally flat plate. The jig 30 includes a plurality of locator pins 31 corresponding in position to the locator holes 22a of the integral set of frames 22. A plurality of openings 30a are defined in the jig 30 and correspond in position to the openings 22c of the integral set of frames 22. A plurality of posts 32 extend from the jig 30 and correspond in position to the terminals 2a of the integral set of frames 22. The posts 32 serve to hold the end of the voice coil 9 as explained hereinunder.

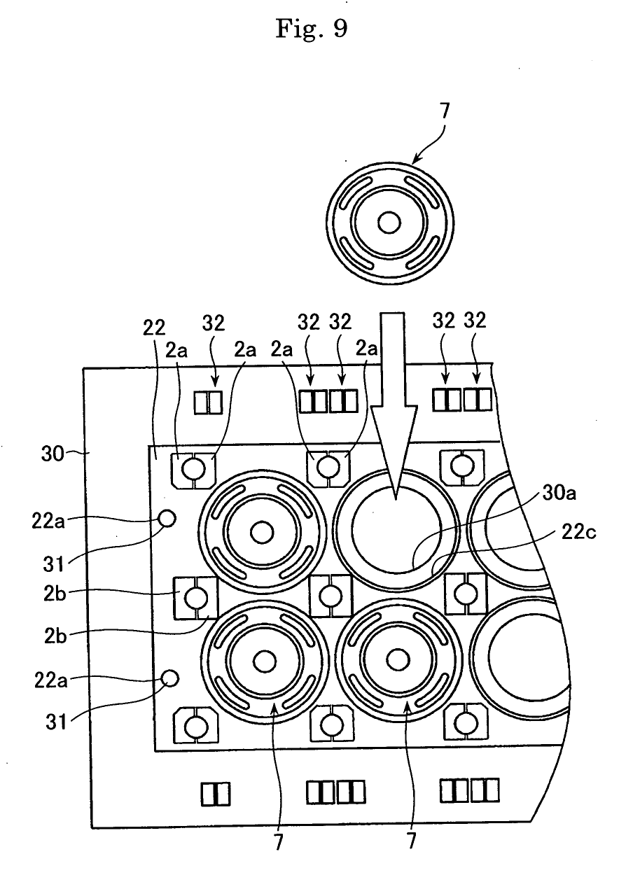

To place the integral set of frames 22 on the jig 30, the locator pins 31 are inserted into the corresponding locator holes 22a as shown in FIG. 9. At this time, the front face of the integral set of frames 22 is oriented in an upward direction. The magnetic circuit unit 7 is mounted within the receptacle opening 22c of the integral set of frames 22 so that the front surface of the stepped peripheral portion 4d of the outer yoke 4 of the magnetic circuit unit 7 is flush with the front surface of the integral set of frames 22.

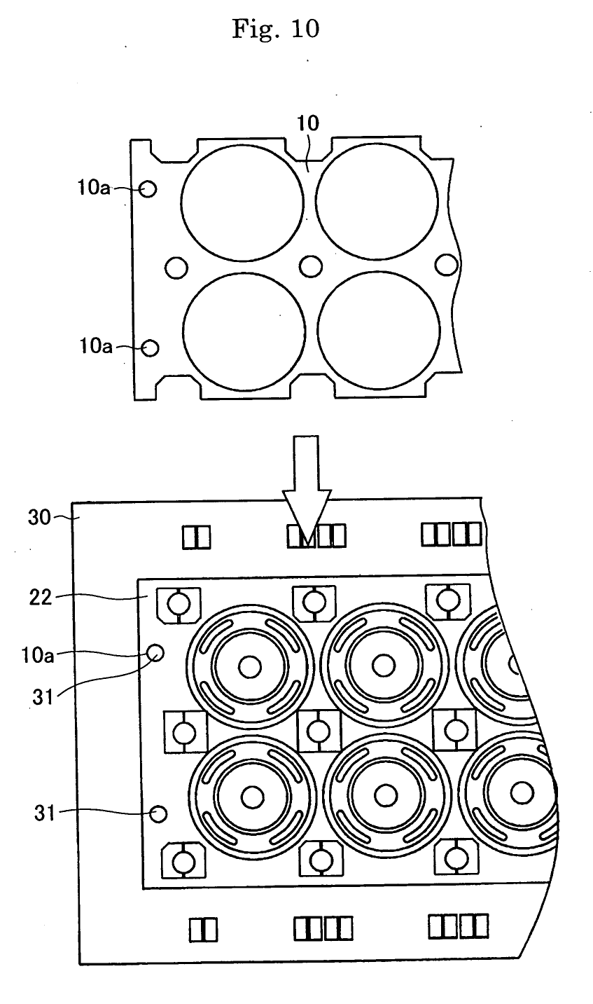

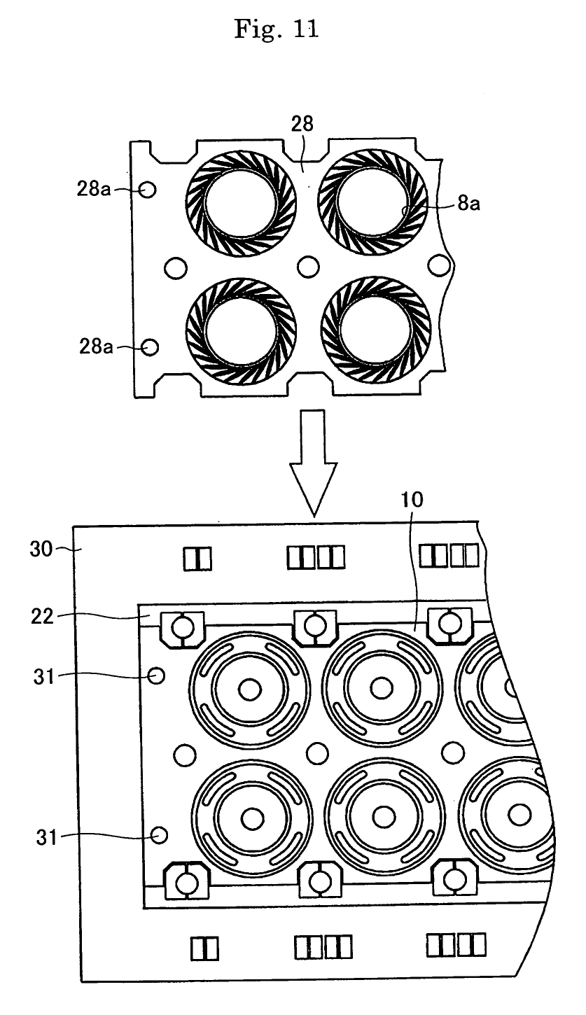

In the step S5, the double-sided adhesive sheet 10 is provided which has substantially the same shape as the integral set of frames 22 and includes a plurality of locator holes 10a as shown in FIG. 10. The adhesive sheet 10 is placed on the integral set of frames 22 with the locator pins 31 inserted through the corresponding locator holes 10a so that the adhesive sheet 10 engages the front surface of the stepped peripheral portion 4d of the outer yoke 4 as well as the front surface of the integral set of frames 22. Prior to the step S5, an integral set of diaphragms 28 is provided in the step S4. The integral set of diaphragms 28 has a plurality of locator holes 28a as shown in FIG. 11. With the locator pins 31 inserted through the corresponding locator holes 28a, the integral set of diaphragms 28 is pressed against the integral set of frames 22 through the adhesive sheet 10. As a result, the integral set of diaphragms 28 is secured to the integral set of frames 22. The stepped peripheral portions 4d of the outer yokes 4 are adhesively joined to the integral set of diaphragms 28 and clamped between the integral set of diaphragms 28 and the annular recesses 2d of the integral set of frames 22 The integral set of diaphragms 22 includes a first longitudinal array of diaphragms 8 and a second longitudinal array of diaphragms 8 extending parallel to each other, as shown in FIG. 11. The diaphragms correspond in position to the frames 2 of the integral set of frames 22.

In the step S6, an adhesive is applied to the annular groove part 8a. Then, the voice coil 9 is fitted into the annular groove part 8a. The voice coil 9 has opposite ends 9a, 9a. The coil ends 9a, 9a run on the diaphragm 8 along a predetermined path. The posts 32 each have a slit. The coil ends 9a, 9a are pressed into the corresponding slits of the posts 32 and soldered to the corresponding terminals 2a. At this time, a portion of each of the coil ends 9a, 9a which extends beyond the post is cut away. The coil ends 9a, 9a are secured to the integral set of diaphragms 28 by means of an adhesive.

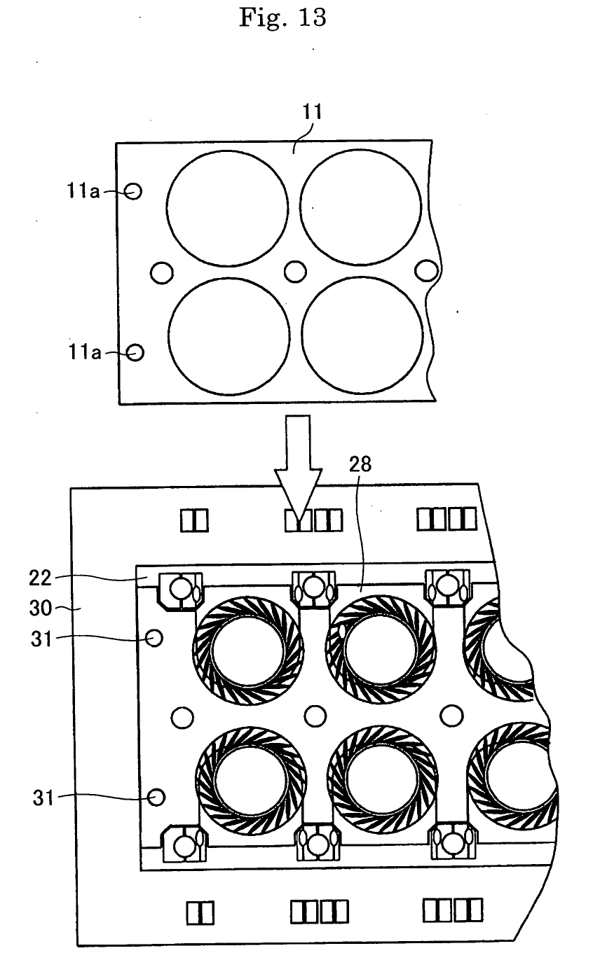

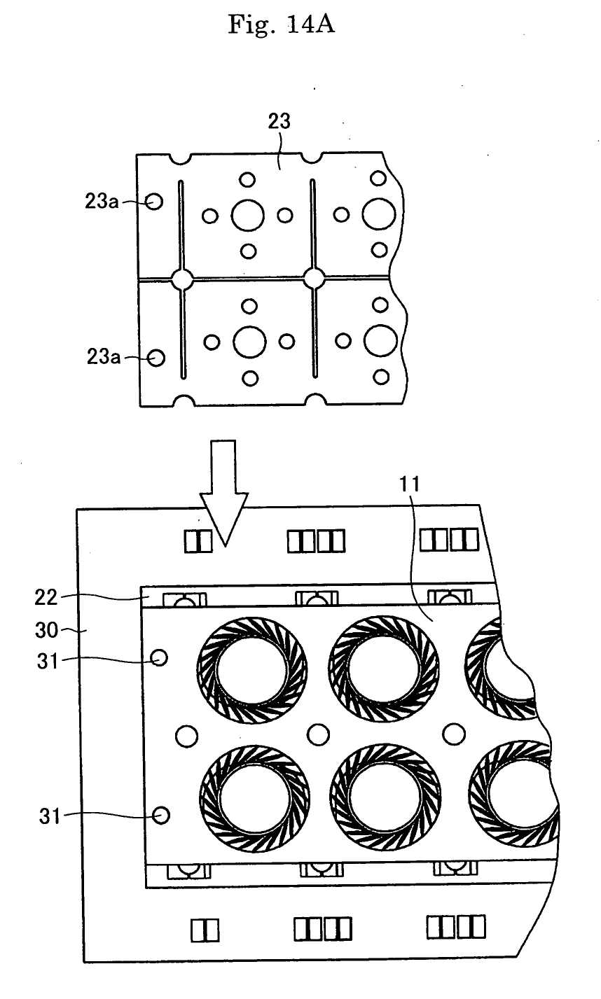

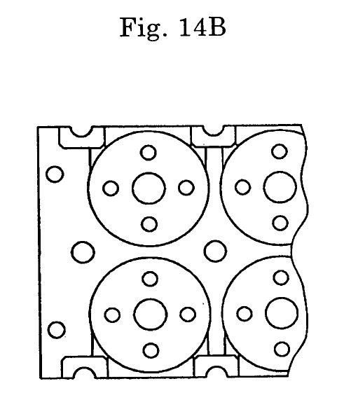

In the step S7, a double-sided adhesive sheet 11 is provided which has substantially the same shape as the integral set of diaphragms 28 and includes a plurality of locator holes 11a, as shown in FIG. 13. With the locator pins 31 inserted through the locator holes 11a, the adhesive sheet 11 is placed on the integral set of diaphragms 28. In the step S8, as shown in FIG. 14, an integral set of protective members 23 has a plurality of locator holes 23a. The locator pins 31 are inserted through the corresponding locator holes 23a with the front face of the integral set of protective members 23 oriented in an upward direction. Then, the integral set of protective members 23 is pressed against the integral set of diaphragms 28 through the adhesive sheet 11. As a result, the integral set of protective members 23 is secured to the integral set of diaphragms 28. The integral set of protective members 23 includes a plurality of integrated units of two protective members as shown in FIG. 4 which units are placed side by side and formed in an integral form.

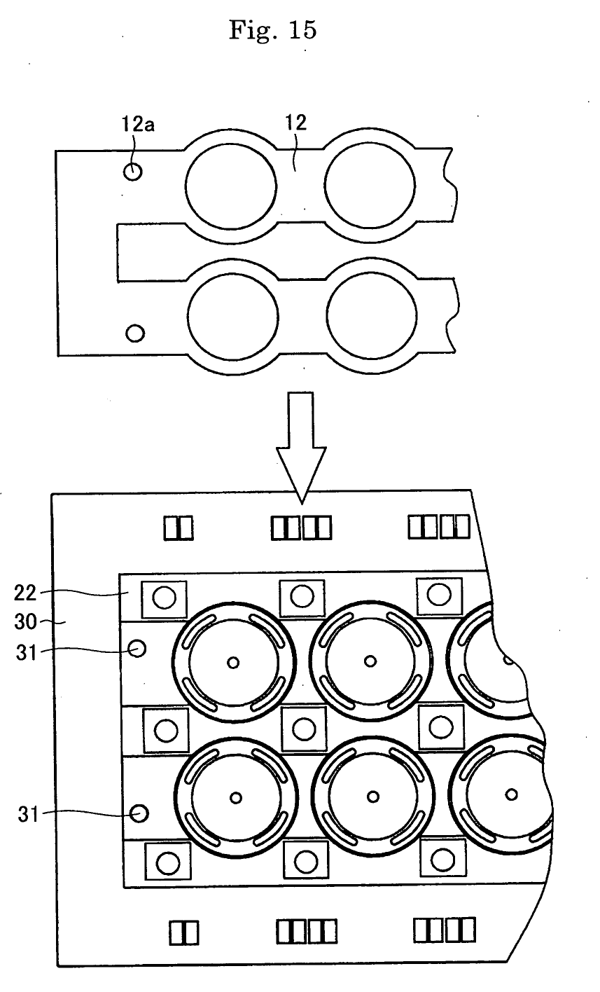

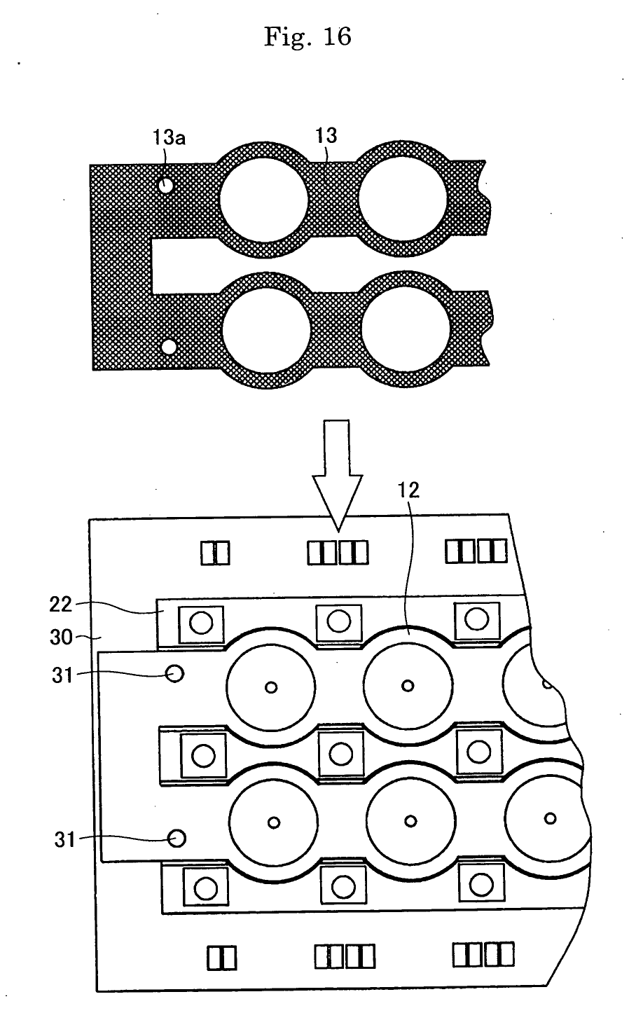

In the step S9, the integral set of frames 22 with the elements mounted thereon as described above is removed from the locator jig 30, then turned upside down and again placed on the locator jig 30 (see FIG. 15). With the locator holes 12a aligned with the locator pins 31, the adhesive sheet 12 is placed on the integral set of frames 22. As shown in FIG. 16, an integral set of rear meshes 13 is adhered to the adhesive sheet 12. A complete set is removed from the locator jig 30. The encapsulating resin 14 is applied to a clearance left between the integral set of frames 22 and the integral set of protective members 23. The encapsulating resin 14 is thereafter dried out.

In the step S10, the magnet 5 of the magnetic circuit unit is magnetized.

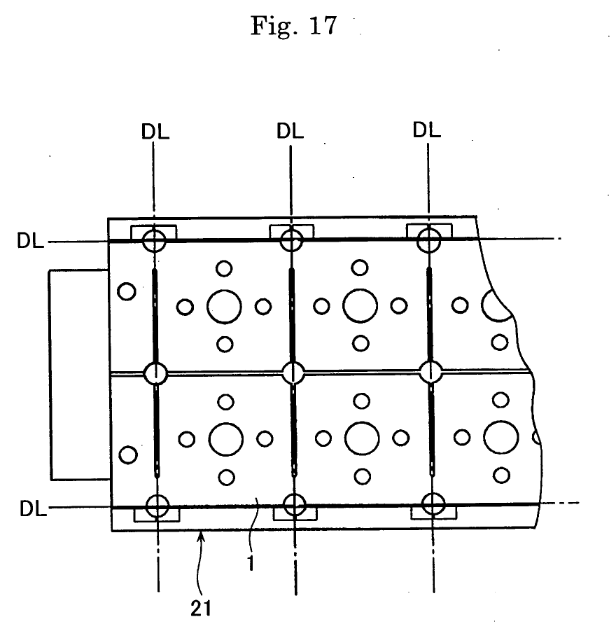

In the step S11, the complete set 21 as thus far made is bonded to a dicing sheet. As shown in FIG. 17, the complete set 21 is then cut along a plurality of dicing lines DL to provide a plurality of speakers, each composed of two speaker units as shown in FIGS. 1 to 4. It should be understood that a plurality of complete sets may be cut at the same time. The complete set 21 may be cut so that each speaker is composed of a single speaker unit rather than two speaker units.

The advantages of the present invention are as follows. Firstly, an integral set of frames, an integral set of protective members and an integral set of diaphragms can be all positioned by a single and common locator jig. This method not only brings about a reduction in the cost of tools or machines required to assemble the various parts of the speaker, but also enables the speakers produced thereby to have uniform quality. Secondly, in a conventional method, a diaphragm and a frame are made on a one-by-one basis. Obviously, the conventional method results in an increase in the time required to mold all the required parts. Besides, all the molded parts must be removed one by one from the molds. Accordingly, the production cost of a speaker will increase. The method of the present invention eliminates such a cumbersome step. According to the present invention, the provision of integrated sets of various parts brings about a reduction in the number of processing steps and assemblage steps and also, enables a speaker to be manufactured with high yields. As mentioned in the step S11, a speaker can be manufactured with a single speaker unit or two or more speaker units. The speaker having more than three speakers may be, for example, used as a surround sound speaker. Further, the magnetic circuit unit can be assembled without the need for an adhesive. A single pin is used to assembly all the parts of the magnetic circuit unit. This reduces the number of production steps.

The present invention has a wide variety of applications such as a cellular phone, a laptop personal computer, a personal digital assistant and a gaming machine.

Although the present invention has been described with respect to its preferred embodiment, it is to be understood that various modifications and changes may be made without departing from the scope of the appended claims.

What is claimed is:

1. A method for manufacturing speakers, comprising the steps of:
(a) providing an integral set of frames wherein a plurality of frames are juxtaposed end to end and integrally connected together;
(b) providing a plurality of magnetic circuit units;
(c) providing an integral set of diaphragms wherein a plurality of diaphragms are juxtaposed end to end and integrally connected together;
(d) providing a plurality of voice coils, each of said voice coils being of a cylindrical shape;
(e) mounting said plurality of magnetic circuit units into said integral set of frames, respectively, so that each of said plurality of magnetic circuit units is received in a receptacle portion of a corresponding frame;
(f) mounting said integral set of diaphragms to said integral set of frames in such a manner that each of said plurality of diaphragms is aligned with a corresponding frame;
(g) mounting said plurality of voice coils onto said plurality of diaphragms, respectively, so that each of said plurality of voice coils is operatively connected to a corresponding magnetic circuit unit, to thereby form an integral set of speaker units each comprising one each from said frames, said magnetic circuit units, said diaphragms and said voice coils; and
(h) separating said integral set of speaker units into a plurality of speakers, each speaker comprising at least one speaker unit.

2. A method for manufacturing a speaker according to claim 1, wherein in said step (b), each of said plurality of magnetic circuit units comprises an outer yoke having a bottom wall and a cylindrical wall elevating from a peripheral edge of said bottom wall, a magnetic element secured on said bottom wall, an inner yoke secured on said magnetic element, wherein an annular magnetic gap is defined between said outer yoke and said inner yoke, and a flange extending radially outwardly from said cylindrical wall of said outer yoke; and,
Wherein in said step (e), said plurality of flanges are engaged with said plurality of frames, respectively.

3. A method for manufacturing a speaker according to claim 2, wherein in said step (c), each of said plurality of diaphragms comprises a central moving part, a radially outer moving part disposed around said central moving part, and an annular groove part connected between said central moving part and said outer moving part and having a U-shape cross section,
wherein in said step (f), said annular groove part of each of said plurality of diaphragms plunges into a magnetic gap of a corresponding magnetic circuit unit, and said plurality of outer moving parts each has a peripheral edge secured to said plurality of frames, respectively, and,
wherein in said step (g), said voice coil is secured within said annular groove part.

4. A method for manufacturing a speaker according to claim 3, further comprising the step of providing a locator jig, said integral set of frames being positioned relative to said locator jig,
wherein in said step (f), said integral set of diaphragms is positioned relative to said locator jig to thereby position said integral set of diaphragms relative to said integral set of frames.

5. A method for manufacturing a speaker according to claim 4, wherein said locator jig comprises a generally flat jig body and a plurality of locator pins projecting from said jig body, said integral set of frames includes a plurality of locator holes, and, said integral set of diaphragms includes a plurality of locator holes, said plurality of locator pins being inserted through said plurality of locator holes of said integral set of frames, respectively, and through said plurality of locator holes of said integral set of diaphragms, respectively, so as to position said integral set of frames and said integral set of diaphragms relative to said locator jig.

6. A method for manufacturing a speaker according to claim 5, further comprising the steps of:
providing a double-sided adhesive sheet, said double-sided adhesive sheet corresponding in shape to said integral set of frames;
placing said adhesive sheet on said integral set of frames while positioning said double-sided adhesive sheet relative to said locator jig; and
securing said integral set of diaphragms to said integral set of frames through said double-sided adhesive sheet while positioning said integral set of diaphragms relative to said locator jig.

7. A method for manufacturing a speaker according to claim 1, wherein in said step (b), each of said plurality of outer yokes has a fixed pin extending axially and centrally from said bottom wall of said outer yoke with branches at a top end of the fixed pin, each of said plurality of magnetic elements is annular in shape and has a hole through which said pin extends, and each of said plurality of inner yokes is annular in shape and has a hole through which said pin extends, said branches of said pin holding together said magnetic element and said inner yoke between said bottom wall of said outer yoke and said branches.

8. A method for manufacturing a speaker according to claim 1, wherein said magnetic element is magnetized before said integral set of speaker units is divided in said step (h).

9. A speaker comprising at least one speaker unit wherein:
said at least one speaker unit comprises:
a magnetic circuit unit comprising an outer yoke having a bottom wall and a cylindrical wall elevating from a peripheral edge of said bottom wall, a magnetic element placed on said bottom wall, and an inner yoke placed on said magnetic element, wherein an annular magnetic gap is defined between said outer yoke and said inner yoke;
a frame for accommodating and supporting said magnetic circuit unit;
a diaphragm secured to said frame; and,
a cylindrical voice coil secured to said diaphragm, wherein the cylindrical voice coil is coaxial with said annular magnetic gap and is at least partially positioned in said annular magnetic gap;
wherein
said magnetic element has a hole extending therethrough in an axial direction of said cylindrical wall of said outer yoke,
said inner yoke has a hole aligned with said central hole of said magnetic element, and
a fixing pin secured to and extending from said bottom wall of said outer yoke through said holes of said magnetic element and said inner yoke, wherein said fixing pin has branches at an end thereof, which hold together magnetic element and said inner yoke between said branches and said bottom wall of said outer yoke.

10. A speaker according to claim 9 in which said diaphragm has an annular groove part plunging from said diaphragm into said magnetic gap, said groove part having an annular groove opening in a direction away from said magnetic gap and receiving said voice coil therein.

11. A speaker according to claim 9 in which said at least one speaker units comprises two speaker units juxtaposed end to end; said frames of said two speaker units are integrally connected together; and said diaphragms of said two speaker units are integrally connected together.

12. A speaker according to claim 10 in which said at least one speaker units comprises two speaker units juxtaposed end to end; said frames of said two speaker units are integrally connected together; and said diaphragms of said two speaker units are integrally connected together.

13. A speaker according to claim 9 in which said frame comprises a printed circuit board.
